(19) United States
(12) Patent Application Publication
(10) Pub. No.: US 2025/0355638 A1
(43) Pub. Date: Nov. 20, 2025

(54) MULTI-MODAL DEVELOPMENT INTERFACE FOR LARGE LANGUAGE MODEL APPLICATIONS

(71) Applicant: Gopal Datt JOSHI, Dublin, CA (US)

(72) Inventor: Gopal Datt JOSHI, Dublin, CA (US)

(21) Appl. No.: 18/828,450

(22) Filed: Sep. 9, 2024

Related U.S. Application Data
(60) Provisional application No. 63/649,642, filed on May 20, 2024.

(51) Int. Cl. G06F 8/34; G06F 3/01

(52) U.S. Cl. CPC G06F 8/34; G06F 3/01

(57) ABSTRACT

The invention provides a multi-modal development interface system for a large language model (LLM) engine. The system includes a multi-modal user input interface that is configured to acquire a plurality of multi-modal inputs from a user. The multi-modal inputs comprise textual and/or non-textual inputs. The system further includes a user input encoder that is configured to encode the acquired multi-modal inputs and to generate LLM inputs for the LLM engine. The system further includes a user review interface that is configured to present the generated LLM inputs to the user and to modify the generated LLM inputs based upon user review inputs. The system further includes an LLM interface that is configured to provide the modified inputs to the LLM engine. The LLM engine is configured to process the modified inputs to generate a desired output.

### PRIORITY STATEMENT

The present application claims priority under 35 U.S.C. § 119 to U.S. patent application No. 63/649,642 filed 20 May 2024 the entire contents of which are hereby incorporated herein by reference.

### FIELD OF INVENTION

Embodiments of the present disclosure relate to generative artificial intelligence, and more particularly, to a multi-modal development interface system for large language model (LLM) engines.

### BACKGROUND

Advancements in the field of generative artificial intelligence, particularly with large language models (LLMs), have significantly impacted computer and mobile systems. LLMs have revolutionized natural language processing (NLP) across a variety of domains, demonstrating remarkable capabilities in interpreting human textual language, storing knowledge, analyzing text, and generating responses in various formats and styles. The exceptional ability of LLMs to understand language and produce coherent responses has generated considerable interest not only within the scientific community but also among businesses, academic institutions, and the general public.

LLMs are based on a transformer architecture usually having a large number of parameters. Training such large models requires a massive amount of text data, to enable them to capture complex language patterns and generate consistent and contextually relevant text. ChatGPT, developed by OpenAI, is a notable large language model that has drawn substantial attention since the release of the first GPT model in 2018. Various other LLM-based applications and interfaces, such as Co-pilots, Assistant, GPTs, LLamaindex, LangChain, and Haystacks are being developed.

In general, LLMs hold a large repository of knowledge and excel at processing and reasoning over user input in the form of text elements, referred to as “input LLM text”. To get a desired response from LLM, the input LLM text may include user intent comprehensively captured with respect to the underlying task/questions, context/background, and processing/reasoning instructions. The completeness of the input LLM text is critical to generate personalized and accurate LLM responses for the user. Typically, users may spend substantial amount of time along with varying levels of cognitive skills to create an appropriate input LLM text to get a desired LLM response. Such factors primarily depend upon the complexity of the required processing and reasoning for the underlying task at hand and also the user's ability to iteratively enhance input LLM text by observing LLM responses.

For example, a common cause of user dissatisfaction with LLMs such as ChatGPT, is its occasional inability to grasp the user intent from textual input components. Here, user dissatisfaction can be characterized in terms of the correctness of the LLM response, cognitive overhead in iteratively shaping the LLM response by modifying input textual elements. In addition, the users often struggle in identifying the next steps to improve outcomes as there is no feedback (error/warning/suggestion) provided in the LLM response to guide users to further shape their input to the LLM. Therefore, users with limited knowledge of LLMs may tend to be substantially dissatisfied and less proactive in the absence of any additional feedback.

In general, a user getting an undesired response from LLM with respect to their underlying intent is primarily due to the incompleteness of the input LLM text (formed using input textual elements provided by the user) received by the LLM engine. For a semantically incomplete input LLM text, the LLM engine implicitly extrapolates the missing aspects of the input required to make the input LLM text complete and then generates a response that is often found ineffective (unsatisfactory) across different groups of users. In the conventional LLM interfaces, a user has only one way to infer the next step by iteratively observing LLM responses with respect to their input changes. During observation, a user attempts to decipher the missing aspect in the input LLM text along with possible ways to resolve it by changing the input textual element on the interface.

### BRIEF DESCRIPTION

The following description is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a multi-modal development interface system for a large language model (LLM) engine is provided. The system includes a multi-modal user input interface that is configured to acquire a plurality of multi-modal inputs from a user. The multi-modal inputs comprise textual and/or non-textual inputs. The system further includes a user input encoder that is configured to encode the acquired multi-modal inputs and to generate LLM inputs for the LLM engine. The system further includes a user review interface that is configured to present the generated LLM inputs to the user and to modify the generated inputs based upon user review inputs. The system further includes an LLM interface that is configured to provide the modified inputs to the LLM engine. The LLM engine is configured to process the modified inputs to generate a desired output.

According to another example embodiment, a system of interconnected multi-modal interfaces integrated with a large language model (LLM), is provided. The system includes a plurality of interconnected agents. Each of the plurality of agents is configured to receive multi-modal inputs and to process the multi-modal inputs via an LLM engine to produce an output. The plurality of agents are further configured to interact with each other to generate a desired system output. Each of the plurality of interconnected agents includes a multi-modal user input interface configured to acquire the multi-modal inputs from a user. The multi-modal inputs include textual and/or non-textual inputs. The system further includes a user input encoder configured to encode the acquired multi-modal inputs and to generate LLM inputs for the respective LLM engine of the agent. The system further includes a user review interface configured to present the generated LLM inputs to the user and to modify inputs based upon user review inputs. The system includes a LLM interface configured to provide the modified inputs to the LLM engine, wherein the LLM engine is configured to process the modified inputs to generate the respective output. Further, the system includes an application configured to receive the system output resulting from the interactions of the plurality of interconnected agents, wherein the application is configured to generate a continuation output through a scheduler.

According to another example embodiment, an integrated large language model (LLM) system having multi-modal development interface is provided. The system includes a memory storing one or more processor-executable routines and a processor communicatively coupled to the memory. The processor is configured to execute one or more processor-executable routines to receive a plurality of multi-modal inputs from a user. The multi-modal inputs comprise textual and/or non-textual inputs. The processor is further configured to process the acquired multi-modal inputs and to generate LLM inputs for the LLM engine. The processor is further configured to receive user review inputs from the user on the generated inputs and to modify the generated LLM inputs based upon the received inputs. The processor is further configured to provide the modified inputs to the LLM engine. The LLM engine is configured to process the modified inputs to generate a desired output.

According to another example embodiment, a method for generating LLM inputs for a LLM engine is provided. The method includes acquiring a plurality of multi-modal inputs provided by a user. The multi-modal inputs comprise textual and/or non-textual inputs. The method further includes converting the acquired multi-modal inputs and to generate LLM inputs for the LLM engine. The method further includes receiving user review inputs on the generated LLM inputs. The method further includes modifying the generated LLM inputs based on the user review inputs to generate modified inputs.

### BRIEF DESCRIPTION OF THE DRAWINGS

The disclosure will be described and explained with additional specificity and detail with the accompanying figures in which:

FIG. 1 is a multi-modal development interface system for a large language model (LLM) engine in accordance with the embodiments of the invention;

FIG. 2 illustrates example components of the multi-modal development interface system of FIG. 1, according to some aspects of the present description;

FIG. 3 illustrates an integrated large language model (LLM) system having a multi-modal development interface, according to some aspects of the present description;

FIG. 4 illustrates an example screenshot of a multi-modal development interface for a LLM engine;

FIG. 5 illustrates an example screenshot of the multi-agent LLM application within the integrated large language model (LLM) system of FIG. 3;

FIG. 6 is a flowchart illustrating the process of generating LLM inputs for a LLM engine using the multi-modal developmental interface system of FIG. 1; and

FIG. 7 is a block diagram of an embodiment of a computing device in which the multi-modal development interface system, described herein, is implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

This section will describe an illustrative architecture for a multi-modal development interface system.

Embodiments of the invention provide a multi-modal development interface system designed to facilitate the integration, management, and utilization of multi-modal inputs for large language model (LLM) engines. These embodiments address significant challenges faced by traditional LLM models, which often struggle with the complexity of handling diverse input types and lack standardized methods for encoding and processing multi-modal interactions. The invention enables users to seamlessly acquire, encode, review, and modify multi-modal inputs, which can include textual and non-textual inputs such as drawings, gestures, and voice notes. The system described herein enhances the overall efficiency, adaptability, and user engagement by allowing users to easily manage and deploy their multi-modal inputs within the LLM interface.

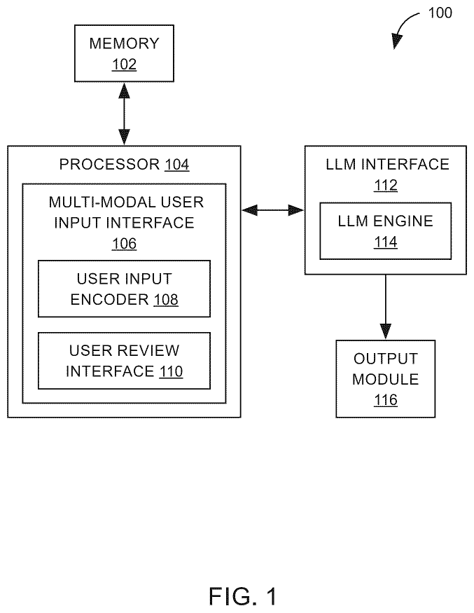

FIG. 1 illustrates a multi-modal development interface system 100 for a large language model (LLM) engine 114 in accordance with the embodiments of the invention. The multi-modal development interface system 100 includes a memory 102, and a processor 104 communicatively coupled to the memory 102. The memory 102 is configured to store one or more processor-executable routines. The processor 104 is configured to execute the one or more processor-executable routines to process multi-modal inputs for the large language model (LLM) engine 114 to generate user-desired output.

In the example embodiment, the processor 104 includes a multi-modal user input interface 106 and a user review interface 110. The processor 104 is configured to receive a plurality of multi-modal user inputs corresponding to multi-modal interactions of the user via the multi-modal user input interface 106. In this example, the multi-modal inputs include textual and/or non-textual inputs. In this embodiment, the non-textual inputs include inputs acquired via multi-modal interactions of the user with the system 100. Examples of multi-modal interactions include, but are not limited to, textual inputs, drawing, annotating, gestures, facial expressions, voice notes, video, images, or combinations thereof.

The multi-modal user input interface 106 is configured to acquire the plurality of multi-modal inputs from a plurality of input sources. Examples of the input sources include but are not limited to, a database, a user-interaction digital device, a repository of files, a uniform resource locator (URLs), or combinations thereof.

The processor 104 is further configured to employ a user input encoder 108 to encode the acquired multi-modal inputs and to generate LLM inputs for the LLM engine 114. For this instance, the user input encoder 108 is configured to process one or more of documents (text), images, video, URLs, and audio to generate LLM inputs for the LLM engine 114.

The processor 104 further includes a user review interface 110 to present the generated LLM inputs to the user. It allows users to review, evaluate, and provide feedback on the generated LLM inputs. Based on the user review inputs, the user review interface 110 enables the user to modify the generated LLM inputs to better align with user intent. The processor 104 is further configured to receive user review input via non-textual inputs.

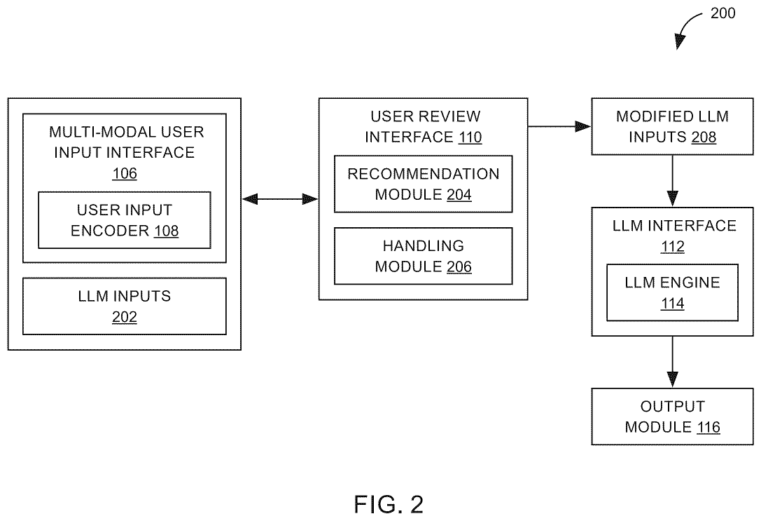

The LLM engine 114 is configured to receive the modified inputs from a LLM interface 112. In this embodiment, the LLM engine 114 is designed to leverage advanced language modelling techniques to generate outputs based on the provided LLM inputs. The LLM engine 114 may include a generative AI-based engine or an autoregressive language model. The LLM engine 114 is further configured to process modified inputs to generate the desired LLM output. Moreover, the system 100 includes an output module 116 configured to present an exportable output generated by the LLM engine 114 to the user. The output module 116 is configured to support various export formats and presentation options, enabling users to receive the output in the format that best suits their needs. The output may include text documents, spreadsheets, reports, or other file formats. The multi-modal development interface system 100 is further described with reference to FIG. 2.

FIG. 2 illustrates example components 200 of the multi-modal development interface system 100 of FIG. 1. As described, the system 100 includes the multi-modal user input interface 106, the user review interface 110, and the LLM interface 112. The multi-modal user input interface 106 is configured to receive a plurality of multi-modal user inputs corresponding to the multi-modal interactions of the user. The multi-modal inputs may include textual and/or non-textual inputs. The non-textual inputs include data obtained through the user's multi-modal interactions via the multi-modal user input interface 106. These multi-modal interactions encompass a variety of interaction mechanisms, including but not limited to, drawing, annotating, gestures, facial expressions, voice notes, video, and images, or any combinations thereof. The multi-modal user input interface 106 is designed to capture and interpret these diverse forms of inputs to ensure comprehensive user engagement and input accuracy.

In operation, the multi-modal user input interface 106 is configured to receive the plurality of multi-modal inputs from a plurality of input sources. In this example, the input sources include but are not limited to, a database, a user-interaction digital device, a repository of files, a uniform resource locator (URLs), or combinations thereof. This implementation allows the system 100 to effectively gather and utilize a wide range of input types, enhancing its versatility and applicability across different user environments and interaction scenarios.

In this example embodiment, the multi-modal user input interface 106 includes the user input encoder 108 that is configured to encode the acquired multi-modal inputs from the users. The user input encoder 108 is further configured to process multi-modal inputs (one or more of documents (text), images, video, URLs, and audio) to generate LLM inputs 202 for the LLM engine 114. This ensures that the multi-modal inputs, regardless of their original format, are translated into a consistent and coherent set of data that the LLM engine 114 can process to generate the desired output. By handling a variety of input types, the user input encoder 108 is configured to enhance the system's capability to interpret and integrate complex user interactions, thereby contributing to the generation of more accurate and relevant outputs from the LLM engine 114.

The user review interface 110 is configured to present the generated LLM inputs 202 to the user in a clear and accessible manner, allowing the user to thoroughly examine and assess the inputs. The user review interface 110 is further configured to modify the generated LLM inputs 202 based upon user review inputs, ensuring that the final inputs accurately reflect the user's intent and requirements.

In operation, the user review interface 110 includes a recommendation module 204 that is configured to analyze the generated LLM inputs 202. The recommendation module 204 is further configured to provide one or more suggestions or feedback on the generated LLM inputs 202, offering potential ways of modifying inputs. The recommendation module 204 is further configured to capture user review inputs and generate modified inputs 208. These recommendations are based on predefined criteria, patterns, and user feedback, aimed at improving the alignment of the LLM inputs 202 with the user's intent and enhancing the overall quality of the system's output. The recommendation module 204 enhances the functionality of the multi-modal user input interface 106 by providing real-time feedback, suggestions, and guidance to users. This relationship ensures that the inputs acquired are of high quality, leading to more accurate and reliable outputs from the LLM engine 114.

The user review interface 110 further includes a handling module 206 that is configured to identify and address errors and faults, that may be present in the generated LLM inputs 202. In operation, the handling module 206 is configured to continuously monitor the LLM inputs 202 for common issues, inconsistencies, and other potential problems that could affect the accuracy and reliability of the data. Upon detecting any such issues, the handling module 206 is configured to generate a warning to alert the user. This warning is designed to be clear and informative, providing details about the nature of the detected issues and potential implications for the LLM inputs 202. By promptly notifying the user of any detected issues, the handling module 206 enables the user to take corrective actions and modify the LLM inputs. The handling module 206 thereby facilitates to maintain the integrity of the LLM inputs 202 while enhancing the overall reliability of the multi-modal development interface system 100.

The LLM interface 112 is configured to receive the modified inputs 208 and to transmit them to the LLM engine 114 for further processing. The LLM interface 112 acts as a crucial conduit, ensuring that the modified inputs 208, which have been tailored to better align with user intent, are accurately fed into the LLM engine 114. The LLM interface 112 ensures seamless communication between the user adjustments and the LLM engine 114, facilitating the effective utilization of the modified inputs in generating outputs that meet user specifications.

The LLM engine 114 is configured to process the modified inputs 208 to generate the desired output. In this embodiment, the LLM engine 114 is designed to leverage advanced language modelling techniques to produce outputs based on the provided inputs. The LLM engine 114 may be based on a generative AI-based engine or an autoregressive language model. By incorporating either the generative AI-based engine or the autoregressive language model, the LLM engine 114 in the multi-modal development interface system 100 is equipped to handle a range of language generation tasks.

In this embodiment, the output module 116 of the multi-modal development interface system 100 is configured to present an exportable output generated by the LLM engine 114 to the user. The output module 116 is configured to support various export formats and presentation options, enabling users to receive the output in the format that best suits their needs. The generated output may include text documents, spreadsheets, reports, or other file formats.

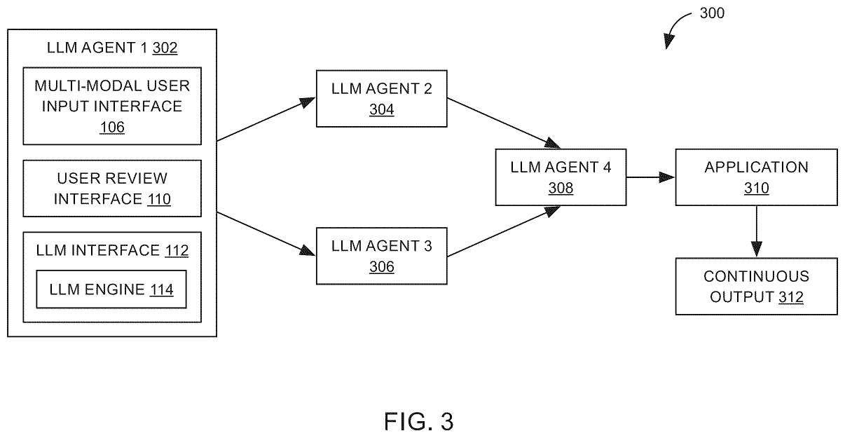

FIG. 3 illustrates an integrated large language model (LLM) system 300 having a multi-modal development interface according to some aspects of present invention. The system 300 includes a plurality of interconnected LLM agents, such as represented by reference numeral 302, 304, 306, and 308, to receive multi-modal LLM inputs and to process the inputs to generate outputs from multi-modal inputs. Each of these plurality of LLM agents such as 302 is configured to receive multi-modal LLM inputs and to process these inputs via an LLM engine 114 to produce an output. The plurality of LLM agents such as 302, 304, 306 and 308 are further configured to interact with each other to generate a desired LLM output. In this example, the architecture of the system 100 is designed to facilitate interaction and collaboration among the LLM agents 302, 304, 306 and 308 to enhance the overall output quality and functionality.

Each of the plurality of interconnected LLM agents such as 302 includes the multi-modal user input interface 106 to acquire inputs from users. These inputs may be both textual and non-textual, gathered through various multi-modal user interactions such as drawing, annotating, gestures, facial expressions, voice notes, videos, images, or combinations thereof. The ability to handle a wide range of input types ensures that the system 300 can interpret and process complex and nuanced user interactions, which are essential for generating accurate and relevant outputs.

Furthermore, the multi-modal user input interface 106 is configured to receive multi-modal inputs from a plurality of data systems and input acquisition interfaces. This capability ensures that the system 300 can handle diverse and large-scale data inputs, enhancing its applicability and utility in various contexts.

In operation, the multi-modal user inputs are processed by the user input encoder 108. The user input encoder 108 is configured to transform the diverse inputs into a format that is suitable for the LLM engine 114. By encoding the acquired multi-modal inputs, the user input encoder 108 generates LLM inputs 202 that the LLM engine 114 can effectively interpret and process.

Each of the plurality of interconnected LLM agents such as 302 further includes the user review interface 110 that is configured to allow users to review the generated LLM inputs 202 in an intuitive and accessible format. The user review interface 110 is further configured to allow users to provide feedback and make modifications to the generated LLM inputs 202 based on their review.

Each of the plurality of interconnected LLM agents 302 further includes the LLM interface that is configured to provide the modified inputs 208 to the respective LLM engine 114 for processing. The LLM engine 114 is configured to process these inputs to generate individual outputs. Each LLM agent 302, while capable of generating individual outputs, is also configured to interact with other LLM agents 304, 306, and 308 within the system 300. These interactions facilitate the generation of a cohesive and comprehensive LLM output.

The integrated large language model (LLM) system 300 includes an application 310 that is configured to receive the LLM output resulting from the interactions of the plurality of interconnected LLM agents 302. The application 310 may be further configured to process the LLM output further to generate a continuation output 312. In this example, the continuation output 312 is output resulting from high-order tasks by leveraging the collective processing power and capabilities of the plurality of interconnected LLM agents 302. The application 310 can be a computer application or other software module designed to utilize the LLM output effectively.

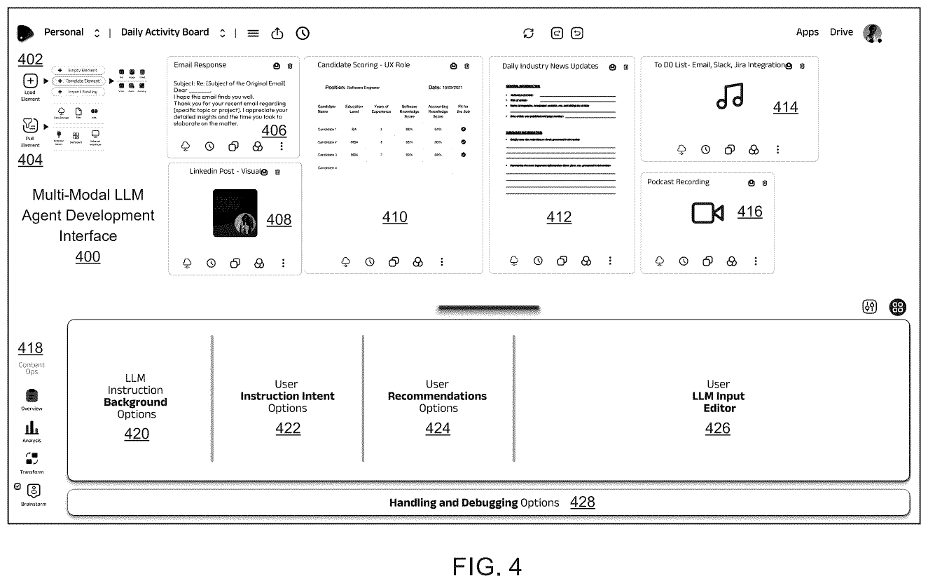

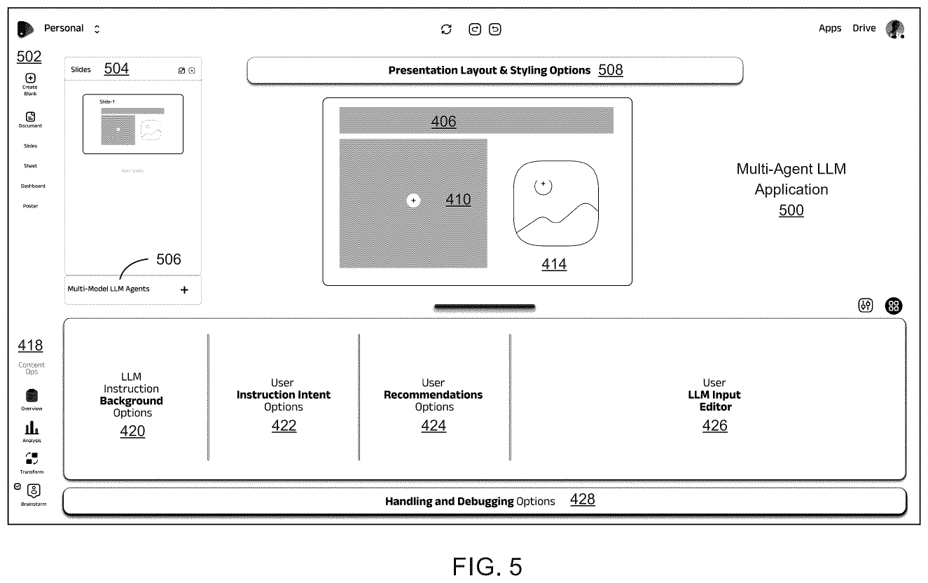

As will be appreciated by one skilled in the art, the integrated large language modal (LLM) system 300 with a multi-modal development interface described above provides a robust and versatile system designed to process and generate outputs using diverse multi-modal inputs. Each of the plurality of interconnected LLM agents such as 302 within the system 300 is configured to acquire, encode, review, and process these inputs, contributing to a cohesive and high-quality LLM output. FIGS. 4 and 5 illustrate an example screenshots of the integrated large language modal (LLM) system 300 of FIG. 3.

FIG. 4 illustrates an example screenshot 400 of the multi-modal development interface for a LLM engine, implemented according to some aspects of the invention.

In this example, the user may either create a plurality of multi-modal inputs via option of “load element” 402 or extract the plurality of multi-modal inputs from an external data system via the option of “pull element” 404. The load element 402 and the pull element 406 options are an integral part of multi-modal user input interface 106. The load element 402 is configured to acquire the multi-modal inputs from the user in the form of text, image, sheet, video, audio, and drawing. The pull element 404 is configured to extract the multi-modal inputs from a plurality of data storage, files, URLs, external devices, dashboards, and external interfaces. As described above, the multi-modal user inputs are processed by the user input encoder 108. The user input encoder 108 is responsible for transforming the diverse inputs into a format that is suitable for the LLM engine 114.

For this instance, the LLM inputs 202 are processed by multi-modal LLM agents, such as represented by reference numeral 406, 408, 410, 412, 414, and 416. Each of the plurality of LLM agents 406 is designed to process specific tasks. Examples of the tasks performed by the different LLM agents include an Email Response (406), a LinkedIn post-visual (408), a Candidate Scoring for UX Role (410), Daily Industry News Updates (412), To-do-List with Email, Slack, and Jira Integration (414), and Podcast Recording (416). Each of these agents is configured to handle specific tasks by processing multi-modal inputs received by options 402 and 404 and producing contextually relevant outputs.

As can be seen, a series of prebuilt LLM instructions 418 are available for various types of LLM agents 406. These instructions are categorized under different functionalities such as “Overview,” “Analysis,” “Transform,” and “Brainstorm.” These prebuilt instructions serve as templates or starting points for users to further customize according to the task-specific requirements of each LLM agent 406.

The example interface 400 also includes the user review interface 110 that is configured to allow users to review the generated LLM inputs 202. In this example interface 400, the recommendation module 204 provides several options, such as LLM Instruction Background 420, User Instruction Intent 422, User Recommendations 424, and the User LLM Editor 426. These features allow users to refine the LLM inputs 202, ensuring that the LLM agents 406 operate with the desired level of precision and alignment with user intent.

As described, the handling module 206 is configured to identify and address errors and faults, that may be present in the generated LLM inputs 202. In the example interface 400, handling and debugging option 428 is provided to the user to address and resolve the issues effectively. This ensures that the system remains robust and that the LLM agents 406 perform optimally. As can be seen, a plurality of options are available to the users to provide the multi-modal inputs and to refine them to align with the intent of the users for processing by the LLM agents.

FIG. 5 illustrates an example screenshot 500 of the multi-agent LLM application within the integrated large language model (LLM) system 300 of FIG. 3, implemented according to some aspects of the invention.

In this example, the multi-agent LLM application 500 illustrates a platform where multiple LLM agents such as represented by reference numeral 406 operate collaboratively to achieve complex, high-order tasks. As described, each LLM agent 406 is typically specialized for a particular function or set of tasks and can communicate with other agents to share information, outputs, and inputs, thereby creating a network of interconnected LLMs that work together seamlessly.

In the integrated large language model (LLM) system 300, the application 310 is configured to receive the final LLM output resulting from the interactions of the plurality of interconnected LLM agents 302, 304, 306 and 308. The application is further configured to process the LLM output further to generate a continuation output 312.

In this example, user may create a new application or create different applications or design new content file using a plurality of tools 502. The tools 502 include “select slide template” 504 and “add desired multi-modal LLM agents” 506, among others. Presentation and layout styling options 508 are available for the user to generate LLM output. In this example, the LLM outputs from all these selected LLM agents 406, 410, and 414 are used to generate a final report.

In addition, a series of prebuilt LLM instructions 418 are available for various types of LLM agents 406. These instructions may be categorized under different functionalities such as “Overview,” “Analysis,” “Transform,” and “Brainstorm.” These prebuilt instructions serve as templates or starting points for users to further customize according to the task-specific requirements of each LLM agent 406.

The example application 500 also includes the user review interface 110 that is configured to allow users to review the generated LLM inputs 202. In this example interface 400, the recommendation module 204 provides several options, such as LLM Instruction Background 420, User Instruction Intent 422, User Recommendations 424, and the User LLM Editor 426. These features allow users to refine the LLM inputs 202, ensuring that the LLM agents 406 operate with the desired level of precision and alignment with user intent.

As described, the handling module 206 is configured to identify and address errors and faults, that may be present in the generated LLM inputs 202. In the example application 500, handling and debugging option 428 is provided to the user to address and resolve the issues effectively.

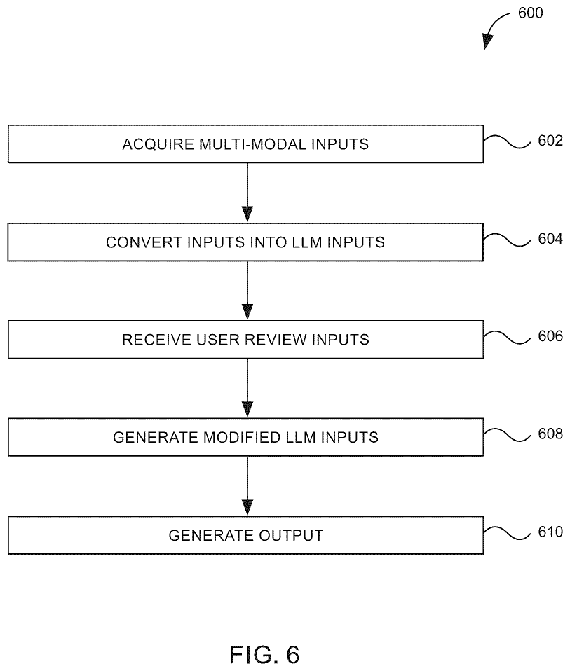

FIG. 6 is a flowchart 600 illustrating the process of generating LLM inputs for a LLM engine using the multi-modal developmental interface system 100 of FIG. 1. At block 602, the system acquires a plurality of multi-modal inputs provided by the user. These inputs include both textual and non-textual forms. Non-textual inputs are acquired through multi-modal interactions of the user, including drawing, annotating, gestures, facial expressions, voice notes, videos, images, or any combination of these methods. These inputs are captured through the multi-modal user input interface designed to handle diverse forms of user interactions.

Once acquired, these multi-modal inputs are converted into the LLM inputs suitable for processing by the LLM engine. This conversion is facilitated by the user input encoder, that processes the acquired multi-modal inputs to generate the corresponding LLM inputs, ensuring they are transformed into a format that the LLM engine can efficiently process. (block 604). Subsequently, the generated LLM inputs are presented to the user through the user review interface, allowing the user to assess and review them. The user review interface enables the user to provide feedback or make modifications to ensure the inputs align with their intent (block 606).

Based on the user review inputs, the method includes modifying the generated LLM inputs. The user review interface incorporates a recommendation module that analyzes the initial LLM inputs and offers suggestions for potential modifications, ensuring the inputs are refined to better match the user's requirements and preferences. The modified inputs are then generated to reflect these refinements accurately (block 608).

At block 610, the modified inputs are processed through the LLM engine, which can be a generative AI-based engine or an autoregressive language model. The LLM engine processes the inputs to produce a desired output, which is then presented to the user through an output module, ensuring the results are accessible and usable. This method leverages a combination of multi-modal user interactions, intelligent input encoding, user feedback, and refined processing to generate high-quality inputs for LLM engines, resulting in outputs that closely align with user intent and requirements.

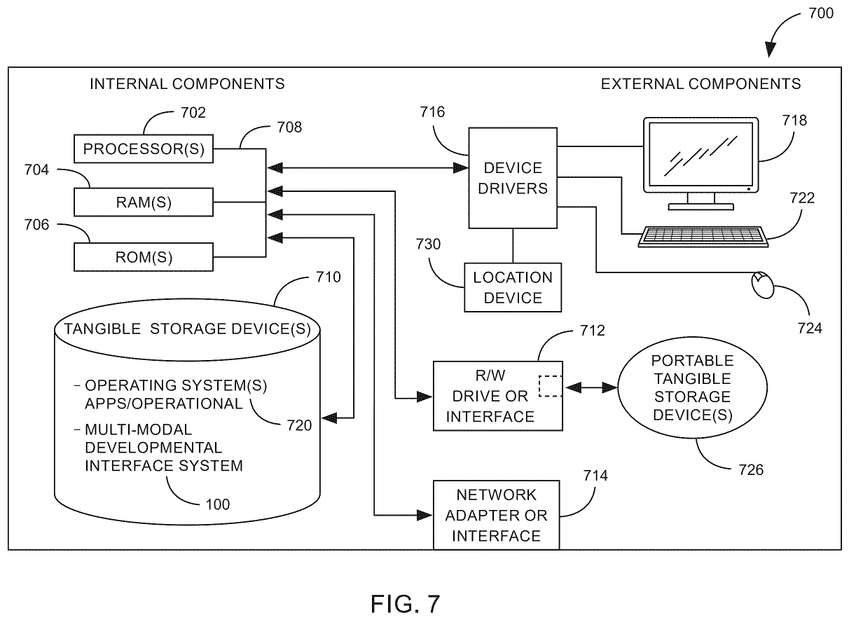

The business process infrastructure modules of the multi-modal development interface system 100 described herein, are implemented in computing devices. One example of a computing device (700) is described below in FIG. 7. The computing device (700) includes one or more processor(s) (702), one or more computer-readable RAMs (704), and one or more computer-readable ROMs (706) on one or more buses (708). Further, the computing device (700) includes a tangible storage device (710) that may be used to execute operating systems (720) and the multi-modal development interface system (100). The various modules of the multi-modal development interface system (100) may be stored in the tangible storage device (710). Both, the operating systems (720) and the multi-modal development interface system (100) are executed by one or more processor(s) (702) via one or more respective RAMs (704) (which typically include cache memory). The execution of the operating systems (720) and/or the multi-modal development interface system (100) by one or more processor(s) (702), configures the one or more processor(s) (702) as a special purpose processor configured to carry out the functionalities of the operation systems (720) and/or the multi-modal development interface system (100) as described above.

Examples of tangible storage devices (710) include semiconductor storage devices such as ROM, EPROM, flash memory, or any other computer-readable tangible storage device that may store a computer program and digital information.

The computing device (700) also includes an R/W drive or interface (714) to read from and write to one or more portable computer-readable tangible storage devices (728) such as a CD-ROM, DVD, memory stick, or semiconductor storage device. Further, network adapters or interfaces (712) such as TCP/IP adapter cards, wireless Wi-Fi interface cards, or 3G or 4G wireless interface cards, or other wired or wireless communication links are also included in computing devices.

In one example embodiment, the multi-modal development interface system (100) may be stored in the tangible storage device (710) and may be downloaded from an external computer via a network (for example, the Internet, a local area network, or other, wide area network) and network adapter or interface (712).

Computing device (700) further includes device drivers (716) to interface with input and output devices. The input and output devices may include a computer display monitor (718), a keyboard (722), a keypad, a touch screen, a computer mouse (724), and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to an example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer-readable medium, and tangible computer program product. For example, the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple p1 that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A multi-modal development interface system for a large language model (LLM) engine, wherein the multi-modal development interface system comprises:
a multi-modal user input interface configured to acquire a plurality of multi-modal inputs from a user, wherein the multi-modal inputs comprise textual and/or non-textual inputs;
a user input encoder configured to encode the acquired multi-modal inputs and to generate LLM inputs for the LLM engine; and
a user review interface configured to present the generated LLM inputs to the user and to modify the generated LLM inputs based upon user review inputs; and
a LLM interface configured to provide the modified inputs to the LLM engine, wherein the LLM engine is configured to process the modified inputs to generate a desired output.

2. The multi-modal development interface system of claim 1, wherein the non-textual inputs comprise inputs acquired via multi-modal interactions of the user with the system and wherein the multi-modal interactions comprise drawing, annotating, gestures, facial expressions, voice notes, video, images, or combinations thereof.

3. The multi-modal development interface system of claim 2, wherein the multi-modal user input interface is configured to acquire the plurality of multi-modal inputs from a plurality of input sources, wherein the input sources comprise a database, a user-interaction digital device, repository of files, uniform resource locator (URLs), or combinations thereof.

4. The multi-modal development interface system of claim 1, wherein the user review interface further comprises a recommendation module configured to provide one or more recommendations to modify the generated LLM inputs.

5. The multi-modal development interface system of claim 4, wherein the user review interface further comprises a handling module configured to detect errors/faults in the inputs to the LLM and to generate warning messages upon such detection.

6. The multi-modal development interface system of claim 1, wherein the system further comprises an output module configured to present an exportable output from the LLM to the user.

7. The multi-modal development interface system of claim 1, wherein the user input encoder is configured to process one or more of documents (text), images, video, URLs, and audio to generate inputs for the LLM engine.

8. A system of interconnected multi-modal interfaces integrated with a large language model (LLM), wherein the LLM system comprises:
a plurality of interconnected agents, each of the plurality of agents configured to receive multi-modal inputs and to process the multi-modal inputs via an LLM engine to produce an output, wherein the plurality of agents are further configured to interact with each other to generate a desired system output and wherein each of the plurality of interconnected agents further comprises:
a multi-modal user input interface configured to acquire the multi-modal inputs from a user, wherein the multi-modal inputs comprise textual and/or non-textual inputs;
a user input encoder configured to encode the acquired multi-modal inputs and to generate LLM inputs for the respective LLM engine of the agent; and
a user review interface configured to present the generated LLM inputs to the user and to modify inputs based upon user review inputs; and
a LLM interface configured to provide the modified inputs to the LLM engine, wherein the LLM engine is configured to process the modified inputs to generate the respective output; and
an application configured to receive the system output resulting from the interactions of the plurality of interconnected agents, wherein the application is configured to generate a continuation output through a scheduler.

9. The system of interconnected multi-modal interfaces of claim 8, wherein the application comprises a computer application configured to achieve a high-order task using the system output.

10. The system of interconnected multi-modal interfaces of claim 8, wherein the plurality of interconnected agents are configured to receive the multi-modal inputs from a plurality of data systems, input acquisition interfaces, or combinations thereof.

11. The system of interconnected multi-modal interfaces of claim 8, wherein the non-textual inputs comprise inputs acquired via multi-modal interactions of the user with the system and wherein the multi-modal interactions comprise drawing, annotating, gestures, facial expressions, voice notes, video, images, or combinations thereof.

12. A multi-modal development interface system for a large language model (LLM) engine, wherein the multi-modal development interface system comprises:
a memory storing one or more processor-executable routines; and
a processor communicatively coupled to the memory, the processor configured to execute the one or more processor-executable routines to:
receive a plurality of multi-modal inputs from a user, wherein the multi-modal inputs comprise textual and/or non-textual inputs;
process the acquired multi-modal inputs to generate LLM inputs for the LLM engine;
receive user review inputs from the user on the generated LLM inputs and modify the generated LLM inputs based upon the received inputs; and
provide the modified inputs to the LLM engine, wherein the LLM engine is configured to process the modified inputs to generate a desired output.

13. The multi-modal development interface system of claim 12, wherein the LLM engine is a generative AI based engine, or an autoregressive language model.

14. The multi-modal development interface system of claim 12, wherein the processor is configured to process one or more of documents (text), images, video, URLs, and audio to generate inputs for the LLM engine.

15. The multi-modal development interface system of claim 12, wherein the processor is further configured to receive user review inputs via non textual inputs.

16. A method of generating LLM inputs for or a LLM engine, the method comprising:
acquiring a plurality of multi-modal inputs provided by a user, wherein the multi-modal inputs comprise textual and/or non-textual inputs;
converting the acquired multi-modal inputs and to generate LLM inputs for the LLM engine;
receiving user review inputs on the generated LLM inputs; and
modifying the generated LLM inputs based on the user review inputs to generate modified inputs.

17. The method of claim 16, wherein the method further comprises processing the generated LLM inputs via the LLM engine and generating a desired output based on the LLM inputs.

18. The method of claim 16, wherein the method further comprises acquiring the multi-modal inputs via multi-modal interactions of the user.

19. The method of claim 18, wherein the method further comprises acquiring the multi-modal inputs via drawing, annotating, gestures, facial expressions, voice notes, video, images, or combinations thereof.

20. The method of claim 16, wherein modifying the generated LLM inputs comprises substantially aligning the generated LLM inputs with user intent.
